(19) United States
(12) Patent Application Publication
(10) Pub. No.: US 2010/0073915 A1
(43) Pub. Date: Mar. 25, 2010

(54) LAMP CASE, AND BACKLIGHT DEVICE AND FLAT DISPLAY DEVICE USING IT

(76) Inventor: Eiji Nittou, Osaka (JP)

Correspondence Address: BIRCH STEWART KOLASCH & BIRCH, PO BOX 747, FALLS CHURCH, VA, 22040-0747, US

(21) Appl. No.: 12/523,148

(22) PCT Filed: Sep. 6, 2007
(86) PCT No.: PCT/JP2007/067393

§ 371 Date: Jul. 14, 2009

(30) Foreign Application Priority Data
Jan. 15, 2007 (JP) 2007-005885

(51) Int. Cl. G02F 1/13357; F21S 4/00

(52) U.S. Cl. 362/97.2; 362/249.01; 362/97.1

(57) ABSTRACT

First protruded strips (12) are formed on the inner surface of the bottom plate (11) of a case body (1) between cold cathode tubes (2), and second protruded strips (13) are so formed on the outer surface of the bottom plate (11) of the case body (1) as to intersect the first strips (12) when viewed from the bottom surface. To further increase the strength of a lamp case (C), it is preferable that the first strips (12) and the second strips (13) intersect each other in substantially vertical direction when viewed from the bottom surface. Furthermore, it is preferable that the first strips (12) and the second strips (13) are formed integrally with the case body (1).

### TECHNICAL FIELD

The present invention relates to a lamp case, and more particularly to a lamp case for use in a backlight device of a so-called direct-lit type.

### BACKGROUND ART

Backlight devices for flat display devices such as liquid crystal display devices roughly divide into a side-lit type and a direct-lit type. In a side-lit backlight device, a light source such as a cold cathode lamp is disposed at a side face of a light guide plate formed out of an acrylic resin plate or the like so that the light from the light source enters the light guide plate via its side face and exits the light guide plate via its face facing the rear face of the display panel. On the other hand, in a direct-lit backlight device, no light guide plate is used, and instead a plurality of linear light sources are fitted at the rear face of a display panel so that the light from the linear light sources is directed to the rear-face side of the display panel through a light-diffusive plate or the like.

Recent years have seen a rapid shift to larger flat display devices such as television receivers and monitors. In large display devices of, for example, 20 inches and over, using side-lit backlight devices leads to insufficient, and possibly also uneven, luminance. For this reason, in large display devices, direct-lit backlight devices are commonly used. Moreover, since direct-lit backlight devices have hollow lamp cases, they are light even when made large, which is an advantage.

As flat display devices are made larger, backlight devices are made larger, and this, in direct-lit backlight devices, leads to reduced strength, and often deformation, of lamp cases for housing linear light sources. In particular, lamp cases made of plastics may deform too much for practical use.

As a solution, Patent Document 1, for instance, proposes a technology of filling with transparent resin the inside of a lamp case having a plurality of fluorescent lamps fitted to it, with a view to preventing deformation or the like of the lamp case under external force.

### Patent Document 1: JP-A-H5-323312.

### DISCLOSURE OF THE INVENTION

### Problems To Be Solved By the Invention

Inconveniently, however, with the proposed technology, filling the inside of a lamp case with resin makes a backlight device heavy. This spoils the advantage of direct-lit backlight devices being light even when made large.

The present invention is made in view of the conventionally encountered inconveniences mentioned above, and an object of the invention is to provide a lamp case for use in a direct-lit backlight device which, even when made large, deforms little without being filled with resin.

Another object of the invention is to provide a backlight device that is light even when made large and that offers even, high luminance.

Yet another object of the invention is to provide a flat display device that is light even when made large and that offers high image display quality.

### Means For Solving the Problem

According to the invention, a lamp case has two or more linear light sources fitted inside it, and has a casing body substantially in the shape of a rectangular parallelepiped open at the top face thereof. Here, on the inner surface of the bottom plate of the casing body, a first ridge is formed between the two or more linear light sources. Moreover, on an outer surface of the bottom plate of the casing body, a second ridge is formed so as to cross the first ridge as seen in a bottom view.

Here from the perspective of efficiently reflecting the light radiated from the linear light sources, the first ridge preferably has a substantially triangular sectional shape as seen in the direction perpendicular to the length direction thereof.

Moreover, from the viewpoint of further increasing the strength of the lamp case, the first and second ridges preferably cross each other substantially perpendicularly as seen in a bottom view. The first and second ridges may be formed integrally with the casing body.

Also covered by the invention is a backlight device provided with: two or more linear light sources; the top-face-open lamp case described above, inside which the linear light sources are fitted; and a light-dispersive plate fitted so as to close the top-face opening of the lamp case.

Specifically, in a backlight device provided with two or more linear light sources, a top-face-open lamp case inside which the linear light sources are fitted, and a light-diffusive plate fitted so as to close the top-face opening of the lamp case, if the lamp case described above is used, the backlight device is covered by the invention.

Also covered by the invention is a flat display device comprising: a display panel; and the backlight device described above, fitted at the rear face of the display panel.

Specifically, in a flat display device provided with: a display panel; and a backlight device fitted on the rear-face side of the display panel, if the backlight device described above is used, the flat display device is covered by the invention.

### Advantages of the Invention

In a lamp case according to the invention, on the inner and outer surfaces of the bottom plate of a casing body, first and second ridges, respectively, are formed to cross each other. Thus, the first and second ridges effectively reduce deformation that tends to develop in large lamp cases. Moreover, since the casing body is hollow, the lamp case is light even when made large.

Giving the first ridge a substantially triangular sectional shape as seen in the direction perpendicular to its length direction allows efficient reflection of the light radiated from the linear light sources on the first ridge. Thus, using a lamp case provided with such a first ridge in a backlight device enhances the light emission efficiency of the backlight device.

Making the first and second ridges cross each other substantially perpendicularly further increases the strength of the lamp case. Forming the first and second ridges integrally with the casing body reduces the number of components, and enhances productivity.

Built with the lamp case described above, a backlight device and a flat display device are light even when made large, and offers even, high luminance combined with high image display quality.

### BRIEF DESCRIPTION OF DRAWINGS

FIG. 1 A perspective view of an example of a lamp case.

FIG. 2 A sectional view along line A-A in FIG. 2,

FIG. 3 A perspective rear view of the lamp case of FIG. 1.

FIG. 4 A sectional view along line B-B in FIG. 3.

FIG. 5 An exploded perspective view of an example of a flat display device.

### LIST OF REFERENCE SYMBOLS

1 Casing body

2 Cold cathode lamp (linear light source)

3 Optical sheet (light-dispersive plate)

C Lamp case

P Liquid crystal display panel (display panel)

11 Bottom plate

12 First ridge

13 Second ridge

14 Pole

15 Holder

### BEST MODE FOR CARRYING OUT THE INVENTION

As embodiments of the invention, a lamp case, and a backlight device and a liquid crystal display device (flat display device) using it, will be described below with reference to the accompanying drawings. It should be understood that these embodiments are not in any way meant to limit the invention.

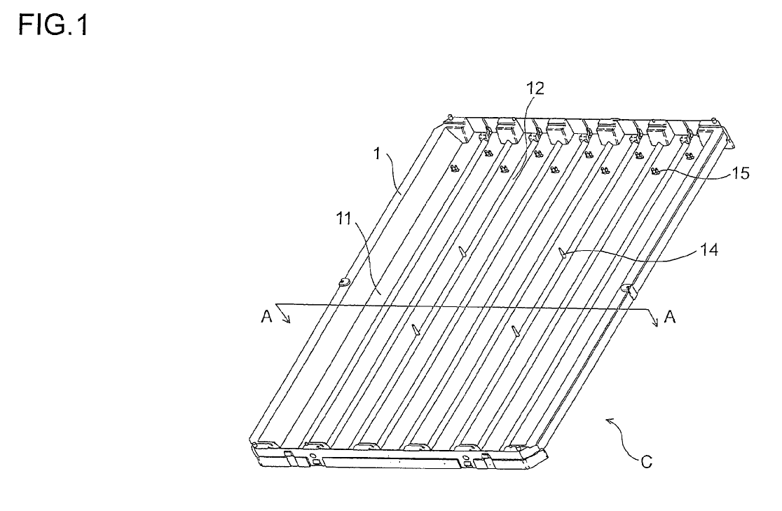

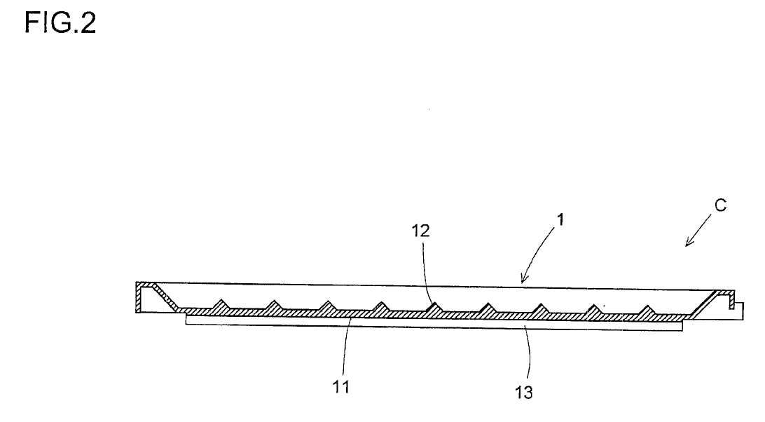

FIG. 1 is a perspective view of a lamp case embodying the invention, and FIG. 2 is a sectional view along line A-A in FIG. 1. The lamp case C shown in FIGS. 1 and 2 has a casing body 1 substantially in the shape of a rectangular parallelepiped open at the top (ceiling) face.

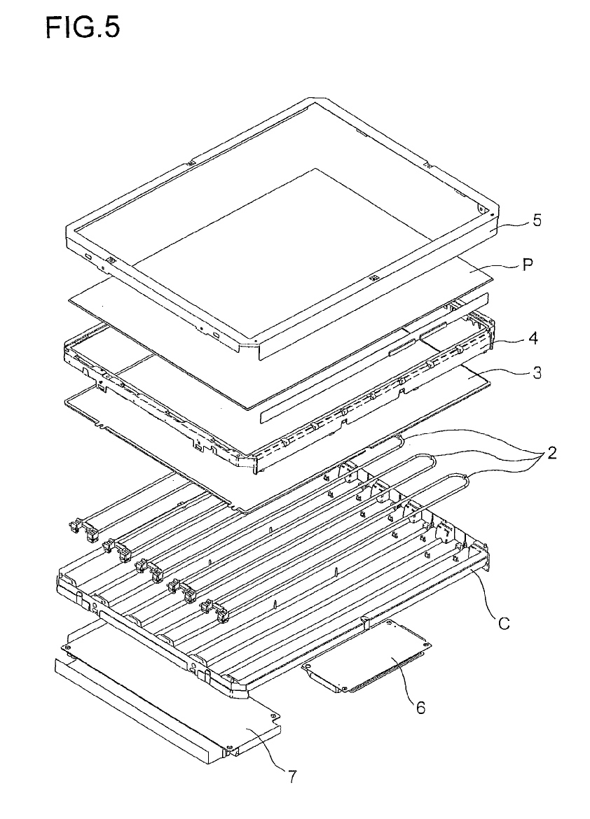

On the inner surface of the bottom plate 11 of the casing body 1, holders 15 and posts 14 are fitted. The holders 15 are for holding cold cathode lamps 2, which are shown in FIG. 5. The posts 14 at their top ends support an optical sheet 3 (a diffusive sheet, a lens sheet, a polarizing sheet, and a light-dispersive plate) as shown in FIG. 5, and thereby close the top-face opening of the casing body 1. The posts 14 are fitted at predetermined intervals from one another on the inner surface of the bottom plate 11 of the casing body 1.

Between adjacent parts of the cold cathode lamps 2 (between linear light sources), a plurality of first ridges 12 are formed parallel to the cold cathode lamps 2.

As will be understood from FIG. 2, the sectional shape of the first ridges 12 as seen in the direction perpendicular to their length direction is triangular. From the viewpoint of reducing deformation of the casing body 1, the sectional shape of the first ridges 12 is not subject to any particular restrictions.

However, from the viewpoint of efficiently reflecting the light radiated from the cold cathode lamps 2 on the bottom surface of the casing body 1 to enhance the light emission efficiency of a backlight device as a whole, the sectional shape of the first ridges 12 is preferably triangular. The height and inclined surface angle of the first ridges 12, whose sectional shape is triangular, are determined appropriately based on the fitting positions of the cold cathode lamps 2 etc.

The first ridges 12 may be formed integrally with the casing body 1, or may be formed separately from the casing body 1 and then fitted to the easing body 1. From the view point of reducing the number of components and of enhancing productivity, the first ridges 12 are preferably formed integrally with the casing body 1. A suitable material for the casing body 1 and the first ridges 12 is a molding of polycarbonate, ABS, or the like.

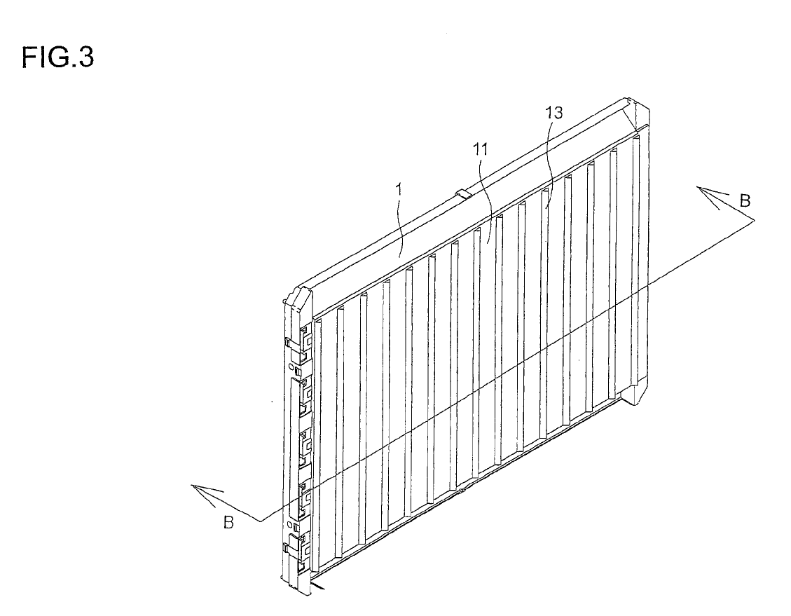

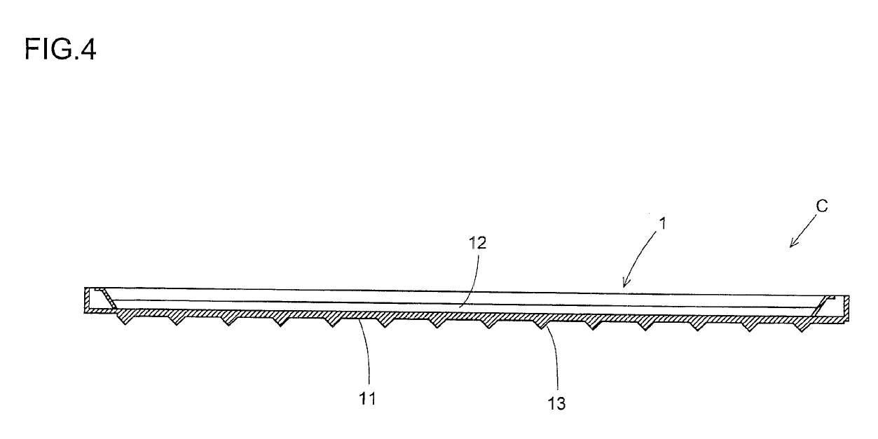

FIG. 3 is a perspective rear view of the lamp case C, and FIG. 4 is a sectional view along line B-B in FIG. 3. On the outer surface of the bottom plate 11 of the bottom plate 11, a plurality of second ridges 13 are formed at predetermined intervals so as to perpendicularly cross the first ridges 12. The second ridges 13 may be formed in any direction in which they cross the first ridges 12, i.e., any direction other than parallel to the first ridges 12. To reduce deformation of the lamp case C under force from all directions, the second ridges 13 are preferably formed to perpendicularly cross the first ridges 12, The intervals between the second ridges 13 are not subject to any particular restrictions; typically, they are preferably 20 to 30 mm.

As will be understood from FIG. 4, the sectional shape of the second ridges 13 as seen in the direction perpendicular to their length direction is triangular. From the viewpoint of reducing deformation of the casing body 1, however, the sectional shape of the second ridges 13 is not subject to any particular restrictions; it may instead be, for example, quadrangular or semicircular. The height of the second ridges 13 also is not subject to any particular restrictions; typically, it is preferably about 2 to 5 mm.

The second ridges 13 may be formed integrally with the casing body 1, or may be formed separately from the casing body 1 and then fitted to the casing body 1. As with the first ridges 12, from the view point of reducing the number of components and of enhancing productivity, the second ridges 13 are preferably formed integrally with the casing body 1.

FIG. 5 is an exploded perspective view of a backlight device, and of a flat display device (surface display device), using the lamp case C described above.

The backlight device is provided with the following: a plurality of cold cathode lamps 2; a lamp case C that fixes and supports, on its inner bottom surface, the cold cathode lamps 2 with holders 15 and that is open at the top face; and an optical sheet (light-dispersive plate) 3 that is fitted so as to close the top-face opening of the lamp case C.

Here, since the lamp case C has the first and second ridges 12 and 13 formed on the inner and outer surfaces, respectively, of its bottom plate 11 so as to cross each other as described above, under external force from any directions, the lamp case C deforms little. Moreover, since the first ridges 12 are formed between, and parallel to, the cold cathode lamps 2, the light radiated from the cold cathode lamps 2 is reflected on the first ridges 12 efficiently, offering high light emission efficiency.

Moreover, since a central part of the optical sheet 3 is supported by the posts 14 formed on the bottom plate 11 of the lamp case C, even in large backlight devices, the central part of the optical sheet warps little. On the rear-face side of the lamp case C, there is fitted an inverter unit 7 for driving the cold cathode lamps 2.

In the liquid crystal display device shown in FIG. 5, on the front-face side of the backlight device, a liquid crystal display panel (display panel) P is disposed. The liquid crystal display panel P is provided with the following: a TFT substrate including pixel electrodes, thin-film transistors, etc.; and a filter substrate including common electrodes, color filters, etc. These substrates are bonded together, with a gap in between, by a sealant applied in a peripheral part of the substrates, and the gap is filled with liquid crystal.

Outside the substrates, unillustrated polarizing plates are fitted respectively. On the rear face of the lamp case C, there is fitted a circuit board 6 for supplying drive signals to unillustrated drain and gate drivers formed on the TFT substrate.

Assembly of the liquid crystal display device shown in FIG. 5 proceeds as follows: the liquid crystal display panel P is held between an upper chassis 4 and a bezel 5, both frame-shaped; then, on the rear-face side of the liquid crystal display panel P, the backlight device is fitted so as to be set inside the upper chassis 4.

1. A lamp case having two or more linear light sources fitted inside it and having a casing body substantially in a shape of a rectangular parallelepiped open at a top face thereof, wherein
on an inner surface of a bottom plate of the casing body, a first ridge is formed between the two or more linear light sources, and
on an outer surface of the bottom plate of the casing body, a second ridge is formed so as to cross the first ridge as seen in a bottom view.

2. The lamp case of claim 1, wherein the first ridge has a substantially triangular sectional shape as seen in a direction perpendicular to a length direction thereof.

3. The lamp case of claim 1, wherein the first and second ridges cross each other substantially perpendicularly as seen in a bottom view.

4. The lamp case of claim 1, wherein the first and second ridges are formed integrally with the casing body.

5. A backlight device comprising:
two or more linear light sources;
the top-face-open lamp case of claim 1, inside which the linear light sources are fitted; and
a light-dispersive plate fitted so as to close the top-face opening of the lamp case.

6. A flat display device comprising:
a display panel;
the backlight device of claim 5, fitted at a rear face of the display panel.
